(19) United States
(12) Patent Application Publication
(10) Pub. No.: US 2026/0222746 A1
(43) Pub. Date: Jul. 30, 2026

(54) HOWLING PREVENTION ALGORITHM FOR HEARING AIDS

(71) Applicant: Starkey Laboratories, Inc., Eden Prairie, MN (US)

(72) Inventors: Piero Iared Rivera Benois, Bad Zwischenahn (DE); Masahiro Sunohara, Plymouth, MN (US); Xianhua Jiang, Eden Prairie, MN (US); Henning Schepker, Oldenburg (DE)

(21) Appl. No.: 19/413,845

(22) Filed: Dec. 9, 2025

Related U.S. Application Data
(60) Provisional application No. 63/751,085, filed on Jan. 29, 2025.

(51) Int. Cl. H04R 25/00

(52) U.S. Cl. CPC H04R 25/453; H04R 25/30

(57) ABSTRACT

An effective howling prevention algorithm may provide improved sound quality of active noise cancellation (ANC) in audio amplification systems, such as in hearing assistance devices. A hearing device includes an inward-facing microphone and receiver, with a controller configured to monitor coherence between microphone and feedback signals to detect potential howling. When howling is detected based on an indicator of instability exceeding a threshold, the controller rapidly converges the gain to zero to prevent feedback howling. After a predetermined delay period without detected howling, the controller slowly converges the gain back to unity to restore active noise cancellation. This approach provides advantages over directly equating coherence to gain by more effectively preventing howling while maintaining optimal noise cancellation performance when stable.

### CROSS-REFERENCE TO RELATED APPLICATIONS

This application claims priority to U.S. Provisional Pat. Appl. No. 63/751,085, titled “HOWLING PREVENTION ALGORITHM FOR HEARING AIDS,” filed Jan. 29, 2025, which is hereby incorporated by reference herein in its entirety.

### TECHNICAL FIELD

Embodiments described herein generally relate to howling prevention in hearing aids (e.g., hearing assistance devices) with active noise cancellation features.

### BACKGROUND

Existing hearing assistance devices, including hearing aids, amplify sound to enable audibility for individuals with hearing loss. These devices may be configured with amplification limits, which may constrain their ability to enhance sound levels. Such constraints arise from technical challenges associated with increasing gain, including acoustic leakage from the receiver to the microphone. This leakage may result in feedback, which may interfere with the device's functionality.

Audio devices may reduce or eliminate feedback through feedback cancellation techniques. Audio devices that employ feedback cancellation include hearing assistance devices, cell phones, public address systems, two-way communication devices (e.g., conference microphones for telephony), and other audio devices. Feedback cancellation may involve passive feedback cancellation, such as physical separation of the microphone and speaker.

Audio devices may improve listening experiences by incorporating active noise cancellation (ANC) techniques. These ANC techniques may include analyzing ambient sound, identifying noise signals, and generating sound signals that are out-of-phase (e.g., 180° out of phase) with the incoming noise. These ANC techniques may combine the out-of-phase signals with input sound to reduce or eliminate unwanted background sounds. This ANC technology aims to create a quieter listening environment, allowing users to focus on desired audio signals without distraction from external noise.

During fitting of a hearing aid, the ANC may be personalized (e.g., optimized) for the individual acoustics inside the ear canal of the patient. This personalization may be based on measuring the receiver-to-inward-facing-mic transfer function. Once an ANC feature is enabled, a mismatch between an actual receiver-to-inward-facing-mic transfer function and an estimated receiver-to-inward-facing-mic transfer function may cause a howling feedback condition. In many cases, this howling feedback condition generates a tone-like sound that is unwanted or annoying to a hearing aid user. Even though the howling feedback includes a loud tone-like sound, the howling feedback cannot be easily discriminated from other loud tone-like sounds in the environment and removed from the hearing aid output, particularly if the receiver-to-inward-facing-mic transfer function has changed in an unknown way.

### BRIEF DESCRIPTION OF THE DRAWINGS

FIG. 1 is a functional block diagram of the howling prevention system, in accordance with at least one embodiment of the invention.

FIG. 2 is a data flow diagram of a howling prevention algorithm, in accordance with at least one embodiment of the invention.

FIG. 3 is a feedback prevention method for preventing ANC feedback in a hearing device, in accordance with at least one embodiment of the invention.

FIG. 4 illustrates a block diagram of an example machine upon which any one or more of the techniques discussed herein may perform.

### DESCRIPTION OF EMBODIMENTS

The subject matter described herein provides technical solutions to address technical problems facing howling in feedback ANC systems. In particular, these solutions are aimed at reducing or preventing howling feedback, which may occur when acoustic feedback in a hearing assistance device reaches levels that produce distortion in the hearing aid receiver. These solutions may be used in hearing aids equipped with ANC, such as to ensure that the earbud has been correctly inserted into the ear canal and that the feedback ANC may be activated without causing howling feedback.

These solutions may include active modification of the feedback ANC parameters within a hearing aid, which may aim to reduce or prevent howling due to unexpected changes in a transfer function between the hearing aid receiver and the hearing aid inward-facing microphone. In another example, it could occur if an ANC controller W(z) includes an adaptive filter, where howling may arise due to the adaptive filter being inappropriate (e.g., incorrect filter coefficients). This active modification may include enabling the ANC, disabling the ANC, or modifying an ANC filter gain. If no howling is detected during a predetermined time, the ANC may be reenabled.

This improved ANC operation functions by monitoring a broadband coherence between the inward-facing microphone signal and the estimated output signal of the ANC feature at the inward-facing microphone. When this coherence drops below a certain threshold, howling is detected, and the gain of the ANC feature is forced to converge rapidly toward zero. Following the ANC converging toward zero, when the howling ceases, the coherence will begin to increase. When this coherence subsequently exceeds a threshold, a countdown timer is started and the howling state is monitored. If no howling is detected during the countdown timer, the gain of the ANC feature is forced to slowly converge toward unity.

The improved ANC operation may include the use of gravity points to provide improved convergence operation. The use of gravity points for convergence reduces or prevents howling feedback, providing improved ANC performance. This improved ANC operation further uses the countdown timer to delay reenabling ANC, which reduces or prevents oscillation between activated and deactivated ANC states, such as when the earbud is not inserted in the ear. This improved ANC operation further provides increased howling feedback detection by the using a detection threshold hysteresis. This detection threshold hysteresis includes setting the detection threshold to a relatively high value when howling is detected, and setting the detection threshold to a relatively low value when howling has been absent for a given amount of time.

The improved ANC operation described herein provides advantages over alternative solutions. For example, the improved ANC operation provides advantages over solutions that may equate ANC gain directly to coherence. In those alternative solutions, the coherence during howling does not drop low enough to set the gain to null or to turn off the ANC feature, so howling may not be mitigated or prevented. These alternative solutions may also not result in coherence being steadily high enough to achieve the improved ANC performance as described herein.

The improved ANC operation further provides advantages over alternative solutions that may rely on proximity sensors. In some alternative solutions, a proximity sensor may be used to determine when ANC is to be activated, however the proximity sensor may not function correctly when the hearing aid not inserted appropriately or not inserted into the ear canal. In contrast, the present improved ANC operation described herein is agnostic regarding the type of earbud type or use of a proximity sensor, which enables them to be used in hearing aids with occluded and open earbud types. The present improved ANC operation further enables reduced or low-power consumption operation, such as by the specific selection of the mathematical quantities used to describe the howling state of the device as described herein.

This description of embodiments of the present subject matter refers to subject matter in the accompanying drawings, which show, by way of illustration, specific aspects and embodiments in which the present subject matter may be practiced. These embodiments are described in sufficient detail to enable those skilled in the art to practice the present subject matter. References to “an,” “one,” or “various” embodiments in this disclosure are not necessarily to the same embodiment, and such references contemplate more than one embodiment. The above detailed description is demonstrative and not to be taken in a limiting sense. The scope of the present subject matter is defined by the appended claims, along with the full scope of legal equivalents to which such claims are entitled.

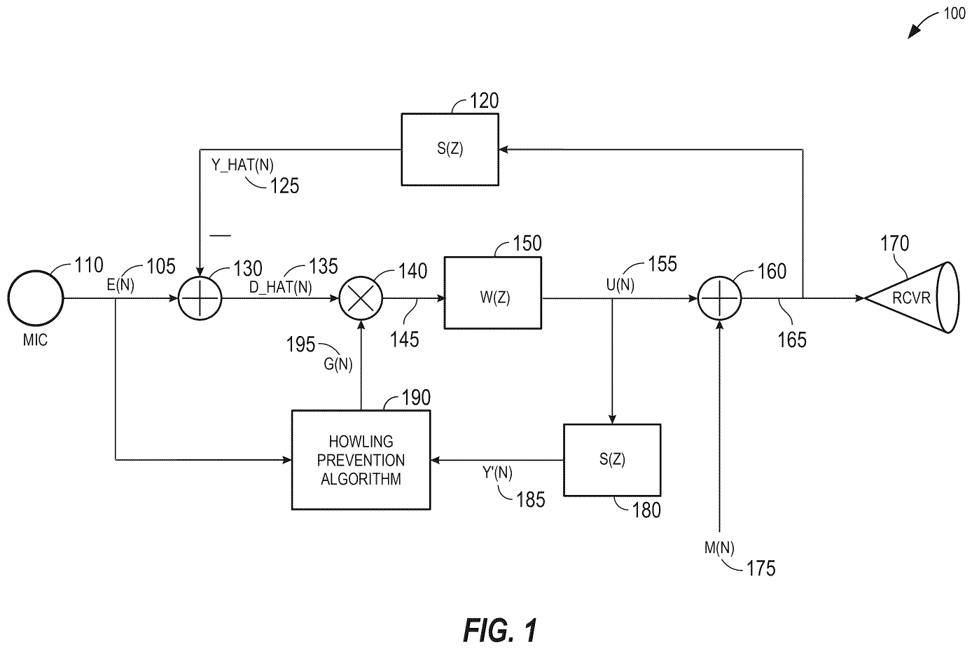

FIG. 1 is a functional block diagram of the howling prevention system 100, in accordance with at least one embodiment of the invention. Howling prevention system 100 may include an inward-facing microphone 110 that generates an inward-facing microphone signal 105, denoted as e(n). An estimated sound pressure 125, denoted as ŷ(n), may be generated by the receiver 170 at the inward-facing microphone transfer function 120 (e.g., first estimated secondary path, estimated receiver-to-inward-facing-mic transfer function), denoted S(z). The estimated sound pressure 125 is subtracted from (e.g., negated and summed with) inward-facing microphone signal 105 at first summing junction 130. The result of that summation is an estimated leaked sound pressure 135, denoted as \hat{d}(n), representing an estimate of sound that leaks from the outside of the ear into the ear canal.

An ANC controller 150, denoted W(z), generates an ANC output signal 155, denoted u(n), based on the estimated leaked sound pressure 135. A streaming audio signal 175, denoted m(n), is summed with the ANC output signal 155 at second summing junction 160 to generate a receiver output signal 165. Depending on the current hearing aid setting, the streaming audio signal 175 may include remotely streamed audio (e.g., from a cellphone), a streamed hearing aid output signal, or a combination of both remotely streamed audio and streamed hearing aid output. The receiver output signal 165 is sent to receiver 170 and to the inward-facing microphone transfer function 120. The inward-facing microphone transfer function 120 uses the receiver output signal 165 to generate estimated sound pressure 125. The estimated sound pressure 125 is then subtracted from the inward-facing microphone signal 105 to update the estimated leaked sound pressure 135.

A howling prevention algorithm function 190 may be used to estimate a sound pressure generated only by the ANC output signal 155 (e.g., excluding the streaming audio signal 175) at the inward-facing microphone 110. The ANC output signal 155 may be filtered by an ANC output filter 180 to generate an ANC filtered signal 185, denoted y′(n), which is further analyzed by the howling prevention algorithm function 190. The howling prevention algorithm function 190 analyzes inward-facing microphone signal 105 and ANC filtered signal 185, and generates an input gain 195, denoted g(n). The input gain 195 is applied to the estimated leaked sound pressure 135 at a product junction 140 to generate a gain-adjusted leaked sound pressure 145, which is used by the ANC controller 150 to generate the ANC output signal 155.

The howling prevention algorithm function 190 is based on an analysis of the coherence between the inward-facing microphone signal 105 and the ANC filtered signal 185. This coherence is given by

$${γ}_{e {y}^{′}} ( n ) = \frac{{\hat{φ}}_{e {y}^{′}} ( n )}{\sqrt{{\hat{φ}}_{e e} ( n ) {\hat{φ}}_{{y}^{′} {y}^{′}} ( n )}} ,$$

where \hat{φ}_{ey′}(n), \hat{φ}ₑₑ (n) and φ_{y′y′}(n) are estimated cross-correlation and auto-correlations of the signals, respectively. These estimations may be calculated recursively over time by using the following general recursive rule:

$${\hat{φ}}_{x y} ( n ) = β \cdot {\hat{φ}}_{x y} ( n - 1 ) + ( 1 - β ) \cdot x ( n ) \cdot y ( n ) .$$

To avoid a division by zero, the denominator used in the invention is calculated as

$$den = max \{ ϵ , \sqrt{{\hat{φ}}_{e e} ( n ) {\hat{φ}}_{{y}^{′} {y}^{′}} ( n )} \} ,$$

where ϵ may be chosen as the smallest number available in the current fixed-point number representation. In an example, this value may be set as ϵ=2⁻⁴⁷.

When howling occurs, the amplitude of the ANC output signal 155 is sufficiently high that it dominates the inward-facing microphone signal 105 over other sound pressure generated by the estimated leaked sound pressure 135 or streaming audio signal 175. In other words, the inward-facing microphone signal given by

$$e ( n ) = d ( n ) + y ( n )$$

is now approximately equal to

$$e ( n ) \approx {y}^{′} ( n ) .$$

Hence, when howling occurs, the coherence γ_{ey′}(n) is substantially equal to one.

The howling prevention algorithm function 190 uses the coherence γ_{ey′}(n) to define the following quantity:

$${α}_{e {y}^{′}} ( n ) = 1 - {γ}_{e {y}^{′}} ( n ) ,$$

which varies between substantially equal to zero (e.g., for howling or coherent signals with the same sign), substantially equal to one (e.g., for completely incoherent or unrelated signals), and substantially equal to two (e.g., for coherent signals with opposite sign).

Various alternative calculations of alpha may be used depending on the state of the streaming audio signal 175. In a first alternative alpha calculation, if ANC is active and streaming audio signal 175 is deactivated, then the ANC output filter 180 may not be needed if the alpha value is calculated as:

$${α}_{e \hat{y}} ( n ) = 1 - \frac{{\hat{φ}}_{e \hat{y}} ( n )}{\sqrt{{\hat{φ}}_{e e} ( n ) {\hat{φ}}_{\hat{y} \hat{y}} ( n )}} .$$

In a second alternative alpha calculation, if ANC is active and streaming audio signal 175 is active with relatively high gain, then the ANC output filter 180 may not be needed if the alpha value is calculated as:

$${α}_{e \hat{d}} = 1 - \frac{{\hat{φ}}_{e \hat{d}} ( n )}{\sqrt{{\hat{φ}}_{e e} ( n ) {\hat{φ}}_{\hat{d} \hat{d}} ( n )}} .$$

In this second alternative alpha calculation, the denominator above remains nonzero, which provides an improved numerical behavior for fixed-point number representation implementations.

The alpha value calculation may be switched during operation. For example, the alpha value calculation may switch between the first and second alternative alpha calculation, such as based on a hearing aid user's preference (e.g., mode selection) to use either only ANC (e.g., with no streaming audio signal 175) or to combine ANC with the streaming audio signal 175 or with a standard hearing aid amplified audio signal. For either of these modes, this may avoid the need for the ANC output filter 180, and the howling prevention algorithm function 190 may be calculated based on inward-facing microphone signal 105 and ANC output signal 155.

The howling prevention algorithm function 190 provides advantages over solutions that use α_{ey′}(n) as the gain of the ANC filter (e.g., g′(n)=α_{ey′}(n)). Because g′(n) is not always low enough to prevent howling, and is not steadily high to ensure improved or maximized ANC performance, the howling prevention algorithm function 190 further analyzes α_{ey′}(n) to calculate a g(n) that substantially equals zero when howling is detected (e.g., turns off ANC) and substantially equals one when howling is not detected (e.g., turns on ANC).

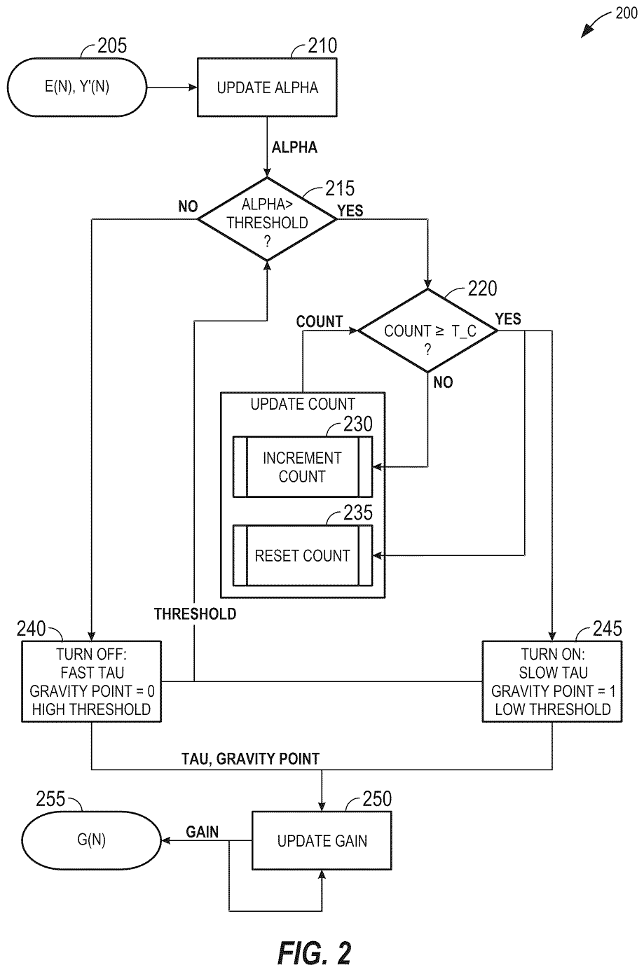

FIG. 2 is a data flow diagram of a howling prevention algorithm 200, in accordance with at least one embodiment of the invention. When new input samples 205 (e.g., e(n) and y′(n)) are available, an alpha update 210 (e.g., update of α_{ey′}(n)) is triggered. At alpha comparison block 215, the updated alpha is compared again a howling-detection threshold, t_{howl}. In an example, this howling-detection threshold may be set relatively high (e.g., t_{howl}=0.35) if howling is present. In another example, the howling-detection threshold may be set low (e.g., t_{howl}=0.25) after howling has been absent for a predetermined amount of time. At alpha comparison block 215, if the alpha is not above the threshold, howling is detected, the howling prevention algorithm 200 implements ANC disable block 240. These ANC disable block 240 may include disabling ANC, such as using the gain update block 250 to update the output gain 255. The gain update block 250 may be used to change the parameters in the gain equation given by

$$g ( n ) = g ( n - 1 ) + τ \cdot ( p - g ( n ) ) ,$$

where p is the so-called gravity point towards which the gain g(n) will converge with a convergence rate controlled by τ, the time constant. To disable ANC, the ANC disable block 240 sets the gravity point to

$$p = 0$$

and the time constant to

$$τ = {τ}_{fast} ,$$

which may be implemented as τ_{fast}=0.75 to provide improved (e.g., artifact-free and rapid) convergence. Additionally, the threshold for alpha may be set to high as

$${t}_{howl} = {t}_{high} .$$

Setting the threshold for alpha in this manner may reduce frequent switching.

If alpha comparison block 215 determines that alpha is above the howling-detection threshold, a howling delay count comparison 220 may be used to introduce a timed delay before reenabling ANC. A timer of X seconds may be set as

$${T}_{c} = X \cdot {f}_{s} ,$$

where fₛ is the sampling frequency. In an example, the timer may be set to X=1 for establishing a minimum of one-second stability before the algorithm reenables ANC.

The howling delay count comparison 220 compares a current value of an incrementing count against T_{c} to determine if the incrementing count has reached the X-second threshold. If the howling delay count comparison 220 determines that the current value the incrementing count is less than T_{c}, then an increment count block 230 may be used to increment the count. If the howling delay count comparison 220 determines that the current value the incrementing count is greater than equal to T_{c}, then a count reset block 235 may be used to reset the count and an ANC reenable block 245 may be used to reenable ANC. To reenable ANC, the ANC reenable block 245 sets the gravity point to

$$p = 1$$

and the time constant to

$$τ = {τ}_{s low} ,$$

which may be chosen as τ_{slow}=0.1, to achieve a slower convergency and substantially artifact-free sound. Additionally, the threshold for alpha is set relatively low, such as

$${t}_{howl} = {t}_{l o w} .$$

By setting the threshold for alpha relatively low, consecutive decisions of the algorithm to reenable ANC do not produce any change in variables, and the hearing aid continues to function under standard (e.g., non-howling) ANC operation. The updated gravity point and time constant may be used by the gain update block 250 to update the output gain 255.

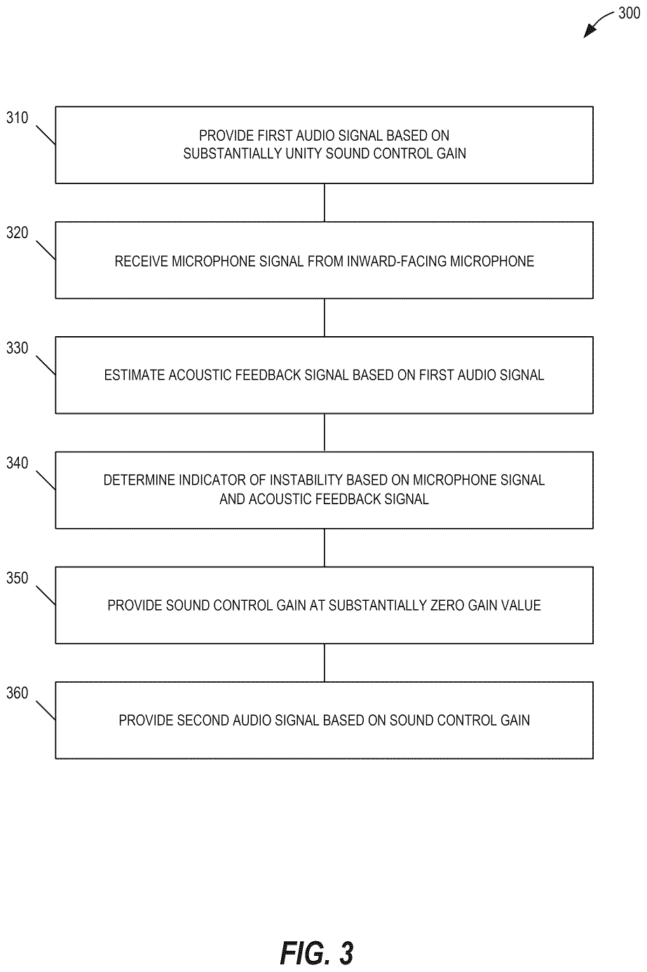

FIG. 3 is a feedback prevention method 300 for preventing ANC feedback in a hearing device, in accordance with at least one embodiment of the invention. The feedback prevention method 300 shown in FIG. 3 provides a procedural representation of the howling prevention methodologies described herein. Method 300 includes providing 310 a first audio signal based on a substantially unity gain value and receiving 320 a microphone signal from an inward-facing microphone. Method 300 further includes estimating 330 an acoustic feedback signal based on the first audio signal and determining 340 an indicator of instability based on the microphone signal and the acoustic feedback signal. Method 300 further includes providing 350, in response to determining the indicator of instability exceeds a howling prevention threshold, a sound control gain at a substantially zero gain value to prevent feedback howling. Method 300 further includes providing 360 a second audio signal based on the sound control gain at the substantially zero gain value. Providing 360 the second audio signal based on the substantially zero gain value reduces or minimizes ANC feedback by interrupting the feedback path between the receiver and inward-facing microphone, thereby reducing or minimizing a howling condition that can occur when an ANC system becomes unstable.

Method 300 may further include maintaining the sound control gain at the substantially zero gain value until determining a stability condition is met for an ANC system. Method 300 may further include evaluating whether stable operating conditions exist by monitoring the ANC feedback interactions between the hearing device's receiver and inward-facing microphone. Method 300 may further include determining the stability condition by monitoring the indicator of instability for a predetermined time period and detecting no instability during the predetermined time period.

Method 300 may further include progressively increasing the sound control gain toward unity after determining the stability condition is met. Increasing the sound control gain toward unity may occur at a first rate that is slower than a second rate used for adjusting the sound control gain toward zero.

Method 300 may further include determining the indicator of instability by calculating a coherence value between the microphone signal and the acoustic feedback signal, converting the coherence value to an alpha value, and comparing the alpha value to the howling prevention threshold. The conversion of the coherence value to an alpha value may include subtracting the coherence value from unity.

Method 300 may further include using a first value for the howling prevention threshold when instability is detected, and using a second value lower than the first value for the howling prevention threshold when instability has not been detected for a predetermined period.

Method 300 may further include determining the alpha value drops below the howling prevention threshold when comparing the alpha value to the howling prevention threshold, where the alpha value represents instability in the ANC feedback path between the receiver and the inward-facing microphone. Method 300 may further include using a set of feedback values that represent a feedback component of an audio signal as the acoustic feedback signal.

Method 300 may further include receiving a streaming audio signal, combining the streaming audio signal with an active noise cancellation signal to generate a receiver signal for ANC operation, and providing the receiver signal to a receiver. Method 300 may further include adjusting the sound control gain using exponential convergence behavior to prevent audio artifacts.

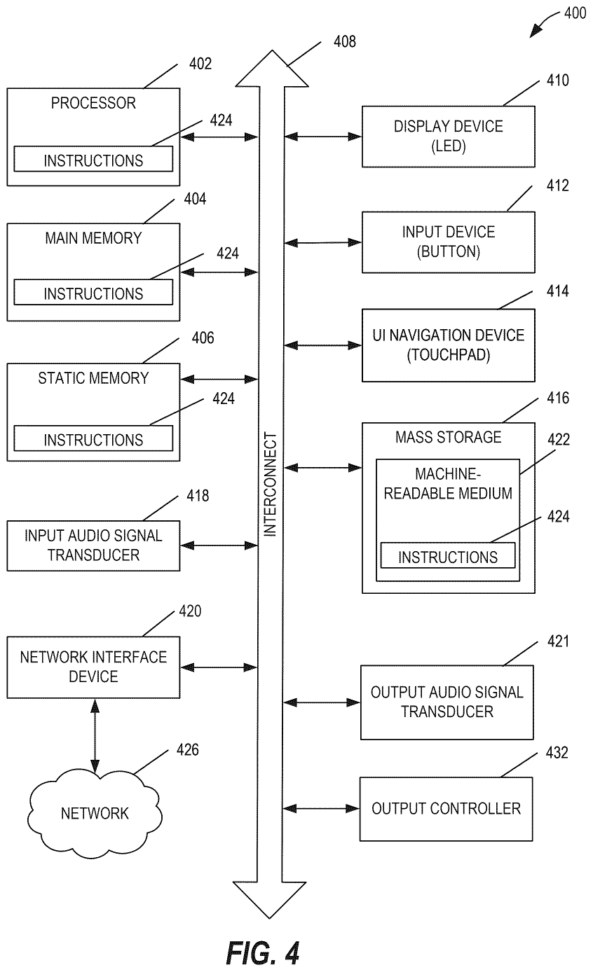

FIG. 4 illustrates a block diagram of an example machine 400 upon which any one or more of the techniques (e.g., methodologies) discussed herein may perform. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine (e.g., computer system) 400 may include a hardware processor 402 (e.g., a central processing unit (CPU), a graphics processing unit (GPU), a hardware processor core, or any combination thereof), a main memory 404 and a static memory 406, some or all of which may communicate with each other via an interlink (e.g., bus) 408. The machine 400 may further include a display unit 410, an alphanumeric input device 412 (e.g., a keyboard), and a user interface (UI) navigation device 414 (e.g., a mouse). In an example, the display unit 410, input device 412 and UI navigation device 414 may be a touch screen display. The machine 400 may additionally include a storage device (e.g., drive unit) 416, one or more input audio signal transducers 418 (e.g., microphone), a network interface device 420, and one or more output audio signal transducer 421 (e.g., speaker). The machine 400 may include an output controller 432, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media.

While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine-readable medium examples may include solid-state memories, and optical and magnetic media. In an example, a massed machine-readable medium comprises a machine-readable medium with a plurality of particles having invariant (e.g., rest) mass. Accordingly, massed machine-readable media are not transitory propagating signals. Specific examples of massed machine-readable media may include: nonvolatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks. The instructions 424 may further be transmitted or received over a communications network 426 using a transmission medium via the network interface device 420 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to communicate wirelessly using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 400, and includes digital or analog communications signals or other intangible medium to facilitate communication of such software.

Various embodiments of the present subject matter may include a hearing assistance device. Hearing assistance devices typically include at least one enclosure or housing, a microphone, hearing assistance device electronics including processing electronics, and a speaker or “receiver.” Hearing assistance devices may include a power source, such as a battery. In various embodiments, the battery may be rechargeable. In various embodiments multiple energy sources may be employed. In various embodiments, detection and reduction or elimination of feedback includes at least one input transducer and at least one output transducer. These input and output transducers may generate feedback when they are within the same domain, such as a pair of acoustic transceivers, a pair of magnetic transceivers, or other types of input and output transducers within the same domain. It is understood that variations in communications protocols, antenna configurations, and combinations of components may be employed without departing from the scope of the present subject matter. Antenna configurations may vary and may be included within an enclosure for the electronics or be external to an enclosure for the electronics. Thus, the examples set forth herein are intended to be demonstrative and not a limiting or exhaustive depiction of variations.

It is understood that digital hearing aids include a processor. In digital hearing aids with a processor, programmable gains may be employed to adjust the hearing aid output to a wearer's particular hearing impairment. The processor may be a digital signal processor (DSP), microprocessor, microcontroller, other digital logic, or combinations thereof. The processing may be done by a single processor, or may be distributed over different devices. The processing of signals referenced in this application may be performed using the processor or over different devices. Processing may be done in the digital domain, the analog domain, or combinations thereof. Processing may be done using subband processing techniques. Processing may be done using frequency domain or time domain approaches. Some processing may involve both frequency and time domain aspects. For brevity, in some examples, drawings may omit certain blocks that perform frequency synthesis, frequency analysis, analog-to-digital conversion, digital-to-analog conversion, amplification, buffering, and certain types of filtering and processing. In various embodiments the processor is adapted to perform instructions stored in one or more memories, which may or may not be explicitly shown. Diverse types of memory may be used, including volatile and nonvolatile forms of memory. In various embodiments, the processor or other processing devices execute instructions to perform a number of signal processing tasks. Such embodiments may include analog components in communication with the processor to perform signal processing tasks, such as sound reception by a microphone, or playing of sound using a receiver (i.e., in applications where such transducers are used). In various embodiments, different realizations of the block diagrams, circuits, and processes set forth herein may be created by one of skill in the art without departing from the scope of the present subject matter.

Various embodiments of the present subject matter support wireless communications with a hearing assistance device. In various embodiments, the wireless communications can include standard or nonstandard communications. Some examples of standard wireless communications include, but not limited to, Bluetooth™, low energy Bluetooth, IEEE 802.11(wireless LANs), 802.15 (WPANs), and 802.16 (WiMAX). Cellular communications may include, but not limited to, CDMA, GSM, ZigBee, and ultra-wideband (UWB) technologies. In various embodiments, the communications are radio frequency communications. In various embodiments, the communications are optical communications, such as infrared communications. In various embodiments, the communications are inductive communications. In various embodiments, the communications are ultrasonic communications. Although embodiments of the present system may be demonstrated as radio communication systems, it is possible that other forms of wireless communications may be used. It is understood that past and present standards may be used. It is also contemplated that future versions of these standards and new future standards may be employed without departing from the scope of the present subject matter.

The wireless communications support a connection from other devices. Such connections include, but are not limited to, one or more mono or stereo connections or digital connections having link protocols including, but not limited to 802.3 (Ethernet), 802.4, 802.5, USB, ATM, Fiber-channel, Firewire or 1394, InfiniBand, or a native streaming interface. In various embodiments, such connections include all past and present link protocols. It is also contemplated that future versions of these protocols and new protocols may be employed without departing from the scope of the present subject matter.

In various embodiments, the present subject matter is used in hearing assistance devices that are configured to communicate with mobile phones. In such embodiments, the hearing assistance device may be operable to perform one or more of the following: answer incoming calls, hang up on calls, and/or provide two-way telephone communications. In various embodiments, the present subject matter is used in hearing assistance devices configured to communicate with packet-based devices. In various embodiments, the present subject matter includes hearing assistance devices configured to communicate with streaming audio devices. In various embodiments, the present subject matter includes hearing assistance devices configured to communicate with Wi-Fi devices. In various embodiments, the present subject matter includes hearing assistance devices capable of being controlled by remote control devices.

It is further understood that different hearing assistance devices may embody the present subject matter without departing from the scope of the present disclosure. The devices depicted in the figures are intended to demonstrate the subject matter, but not necessarily in a limited, exhaustive, or exclusive sense. It is also understood that the present subject matter may be used with a device designed for use in the right ear or the left ear or both ears of the wearer. The present subject matter may be employed in hearing assistance devices, such as headsets, hearing aids, headphones, and similar hearing devices. The present subject matter may be employed in hearing assistance devices having additional sensors. Such sensors include, but are not limited to, magnetic field sensors, telecoils, temperature sensors, accelerometers, and proximity sensors. The present subject matter may be employed in amplification systems other than hearing assistance devices, such as sound reinforcement systems, telephony, and other acoustic amplification and reproduction systems.

The present subject matter is demonstrated for hearing assistance devices, including hearing aids, including but not limited to, behind-the-ear (BTE), in-the-ear (ITE), in-the-canal (ITC), receiver-in-canal (RIC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user, including but not limited to receiver-in-canal (RIC) or receiver-in-the-ear (RITE) designs. The present subject matter can also be used in hearing assistance devices generally, such as cochlear implant type hearing devices and such as deep insertion devices having a transducer, such as a receiver or microphone, whether custom fitted, standard fitted, open fitted and/or occlusive fitted. It is understood that other hearing assistance devices not expressly stated herein may be used in conjunction with the present subject matter.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Example 1 is a hearing device comprising: an inward-facing microphone; a receiver for producing sound; and a controller including one or more processors and operatively coupled to the inward-facing microphone and the receiver, the controller configured to: provide a first audio signal based on a substantially unity gain value; receive a microphone signal provided by the inward-facing microphone; estimate an acoustic feedback signal based on the first audio signal; determine an indicator of instability based on the microphone signal and the acoustic feedback signal; provide, in response to determining the indicator of instability exceeds a howling prevention threshold, a sound control gain at a substantially zero gain value to prevent feedback howling; and provide a second audio signal based on the sound control gain at the substantially zero gain value.

In Example 2, the subject matter of Example 1 includes wherein the controller is further configured to maintain the sound control gain at the substantially zero gain value until determining a stability condition is met.

In Example 3, the subject matter of Example 2 includes wherein determining the stability condition includes: monitoring the indicator of instability for a predetermined time period; and detecting no instability during the predetermined time period.

In Example 4, the subject matter of Examples 2-3 includes wherein the controller is further configured to progressively increase the sound control gain toward unity after determining the stability condition is met.

In Example 5, the subject matter of Example 4 includes wherein a first rate of increasing the sound control gain toward unity is slower than a second rate of adjusting the sound control gain toward zero.

In Example 6, the subject matter of Examples 1-5 includes wherein determining the indicator of instability includes: calculating a coherence value between the microphone signal and the acoustic feedback signal; converting the coherence value to an alpha value; and comparing the alpha value to the howling prevention threshold.

In Example 7, the subject matter of Example 6 includes wherein: the howling prevention threshold includes a first value when instability is detected; and the howling prevention threshold includes a second value lower than the first value when instability has not been detected for a predetermined period.

In Example 8, the subject matter of Examples 6-7 includes wherein comparing the alpha value to the howling prevention threshold includes determining the alpha value drops below the howling prevention threshold.

In Example 9, the subject matter of Examples 1-8 includes wherein the acoustic feedback signal includes a set of feedback values that represent a feedback component of an audio signal.

In Example 10, the subject matter of Examples 1-9 includes wherein the controller is further configured to: receive a streaming audio signal; combine the streaming audio signal with an active noise cancellation signal to generate a receiver signal; and provide the receiver signal to the receiver.

In Example 11, the subject matter of Examples 1-10 includes wherein the controller is configured to adjust the sound control gain using exponential convergence behavior to prevent audio artifacts.

Example 12 is a method of preventing feedback in a hearing device, the method comprising: providing a first audio signal based on a substantially unity gain value; receiving a microphone signal from an inward-facing microphone; estimating an acoustic feedback signal based on the first audio signal; determining an indicator of instability based on the microphone signal and the acoustic feedback signal; providing, in response to determining the indicator of instability exceeds a howling prevention threshold, a sound control gain at a substantially zero gain value to prevent feedback howling; and providing a second audio signal based on the sound control gain at the substantially zero gain value.

In Example 13, the subject matter of Example 12 includes maintaining the sound control gain at the substantially zero gain value until determining a stability condition is met.

In Example 14, the subject matter of Example 13 includes wherein determining the stability condition includes: monitoring the indicator of instability for a predetermined time period; and detecting no instability during the predetermined time period.

In Example 15, the subject matter of Examples 13-14 includes progressively increasing the sound control gain toward unity after determining the stability condition is met.

In Example 16, the subject matter of Example 15 includes wherein a first rate of increasing the sound control gain toward unity is slower than a second rate of adjusting the sound control gain toward zero.

In Example 17, the subject matter of Examples 12-16 includes wherein determining the indicator of instability includes: calculating a coherence value between the microphone signal and the acoustic feedback signal; converting the coherence value to an alpha value; and comparing the alpha value to the howling prevention threshold.

In Example 18, the subject matter of Example 17 includes wherein: the howling prevention threshold includes a first value when instability is detected; and the howling prevention threshold includes a second value lower than the first value when instability has not been detected for a predetermined period.

In Example 19, the subject matter of Examples 17-18 includes wherein comparing the alpha value to the howling prevention threshold includes determining the alpha value drops below the howling prevention threshold.

In Example 20, the subject matter of Examples 12-19 includes wherein the acoustic feedback signal includes a set of feedback values that represent a feedback component of an audio signal.

In Example 21, the subject matter of Examples 12-20 includes receiving a streaming audio signal; combining the streaming audio signal with an active noise cancellation signal to generate a receiver signal; and providing the receiver signal to a receiver.

In Example 22, the subject matter of Examples 12-21 includes adjusting the sound control gain using exponential convergence behavior to prevent audio artifacts.

Example 23 is a non-transitory computer-readable medium including instructions that, when executed by one or more processors of a hearing device, cause the one or more processors to perform operations for preventing feedback, the operations comprising: providing a first audio signal based on a substantially unity gain value; receiving a microphone signal from an inward-facing microphone; estimating an acoustic feedback signal based on the first audio signal; determining an indicator of instability based on the microphone signal and the acoustic feedback signal; providing, in response to determining the indicator of instability exceeds a howling prevention threshold, a sound control gain at a substantially zero gain value to prevent feedback howling; and providing a second audio signal based on the sound control gain at the substantially zero gain value.

In Example 24, the subject matter of Example 23 includes the operations further including maintaining the sound control gain at the substantially zero gain value until determining a stability condition is met.

In Example 25, the subject matter of Example 24 includes wherein determining the stability condition includes: monitoring the indicator of instability for a predetermined time period; and detecting no instability during the predetermined time period.

In Example 26, the subject matter of Examples 24-25 includes the operations further including progressively increasing the sound control gain toward unity after determining the stability condition is met.

In Example 27, the subject matter of Example 26 includes wherein a first rate of increasing the sound control gain toward unity is slower than a second rate of adjusting the sound control gain toward zero.

In Example 28, the subject matter of Examples 23-27 includes wherein determining the indicator of instability includes: calculating a coherence value between the microphone signal and the acoustic feedback signal; converting the coherence value to an alpha value; and comparing the alpha value to the howling prevention threshold.

In Example 29, the subject matter of Example 28 includes wherein: the howling prevention threshold includes a first value when instability is detected; and the howling prevention threshold includes a second value lower than the first value when instability has not been detected for a predetermined period.

In Example 30, the subject matter of Examples 28-29 includes wherein comparing the alpha value to the howling prevention threshold includes determining the alpha value drops below the howling prevention threshold.

In Example 31, the subject matter of Examples 23-30 includes wherein the acoustic feedback signal includes a set of feedback values that represent a feedback component of an audio signal.

In Example 32, the subject matter of Examples 23-31 includes the operations further including: receiving a streaming audio signal; combining the streaming audio signal with an active noise cancellation signal to generate a receiver signal; and providing the receiver signal to a receiver.

In Example 33, the subject matter of Examples 23-32 includes the operations further including adjusting the sound control gain using exponential convergence behavior to prevent audio artifacts.

Example 34 is at least one machine-readable medium including instructions that, when executed by processing circuitry, cause the processing circuitry to perform operations to implement of any of Examples 1-33.

Example 35 is an apparatus comprising means to implement of any of Examples 1-33.

Example 36 is a system to implement of any of Examples 1-33.

Example 37 is a method to implement of any of Examples 1-33.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A hearing device comprising:
an inward-facing microphone;
a receiver for producing sound; and
a controller including one or more processors and operatively coupled to the inward-facing microphone and the receiver, the controller configured to:
provide a first audio signal based on a substantially unity gain value;
receive a microphone signal provided by the inward-facing microphone;
estimate an acoustic feedback signal based on the first audio signal;
determine an indicator of instability based on the microphone signal and the acoustic feedback signal;
provide, in response to determining the indicator of instability exceeds a howling prevention threshold, a sound control gain at a substantially zero gain value to prevent feedback howling; and
provide a second audio signal based on the sound control gain at the substantially zero gain value.

2. The hearing device of claim 1, wherein the controller is further configured to maintain the sound control gain at the substantially zero gain value until determining a stability condition is met.

3. The hearing device of claim 2, wherein determining the stability condition includes:
monitoring the indicator of instability for a predetermined time period; and
detecting no instability during the predetermined time period.

4. The hearing device of claim 2, wherein the controller is further configured to progressively increase the sound control gain toward unity after determining the stability condition is met.

5. The hearing device of claim 4, wherein a first rate of increasing the sound control gain toward unity is slower than a second rate of adjusting the sound control gain toward zero.

6. The hearing device of claim 1, wherein determining the indicator of instability includes:
calculating a coherence value between the microphone signal and the acoustic feedback signal;
converting the coherence value to an alpha value; and
comparing the alpha value to the howling prevention threshold.

7. The hearing device of claim 6, wherein:
the howling prevention threshold includes a first value when instability is detected; and
the howling prevention threshold includes a second value lower than the first value when instability has not been detected for a predetermined period.

8. The hearing device of claim 1, wherein the controller is further configured to:
receive a streaming audio signal;
combine the streaming audio signal with an active noise cancellation signal to generate a receiver signal; and
provide the receiver signal to the receiver.

9. The hearing device of claim 1, wherein the controller is configured to adjust the sound control gain using exponential convergence behavior to prevent audio artifacts.

10. A method of preventing feedback in a hearing device, the method comprising:
providing a first audio signal based on a substantially unity gain value;
receiving a microphone signal from an inward-facing microphone;
estimating an acoustic feedback signal based on the first audio signal;
determining an indicator of instability based on the microphone signal and the acoustic feedback signal;
providing, in response to determining the indicator of instability exceeds a howling prevention threshold, a sound control gain at a substantially zero gain value to prevent feedback howling; and
providing a second audio signal based on the sound control gain at the substantially zero gain value.

11. The method of claim 10, further including maintaining the sound control gain at the substantially zero gain value until determining a stability condition is met.

12. The method of claim 11, wherein determining the stability condition includes:
monitoring the indicator of instability for a predetermined time period; and
detecting no instability during the predetermined time period.

13. The method of claim 11, further including progressively increasing the sound control gain toward unity after determining the stability condition is met.

14. The method of claim 10, wherein determining the indicator of instability includes:
calculating a coherence value between the microphone signal and the acoustic feedback signal;
converting the coherence value to an alpha value; and
comparing the alpha value to the howling prevention threshold.

15. The method of claim 14, wherein:
the howling prevention threshold includes a first value when instability is detected; and
the howling prevention threshold includes a second value lower than the first value when instability has not been detected for a predetermined period.

16. The method of claim 10, further including adjusting the sound control gain using exponential convergence behavior to prevent audio artifacts.

17. A non-transitory computer-readable medium including instructions that, when executed by one or more processors of a hearing device, cause the one or more processors to perform operations for preventing feedback, the operations comprising:
providing a first audio signal based on a substantially unity gain value;
receiving a microphone signal from an inward-facing microphone;
estimating an acoustic feedback signal based on the first audio signal;
determining an indicator of instability based on the microphone signal and the acoustic feedback signal;
providing, in response to determining the indicator of instability exceeds a howling prevention threshold, a sound control gain at a substantially zero gain value to prevent feedback howling; and
providing a second audio signal based on the sound control gain at the substantially zero gain value.

18. The non-transitory computer-readable medium of claim 17, the operations further including maintaining the sound control gain at the substantially zero gain value until determining a stability condition is met.

19. The non-transitory computer-readable medium of claim 17, wherein determining the indicator of instability includes:
calculating a coherence value between the microphone signal and the acoustic feedback signal;
converting the coherence value to an alpha value; and
comparing the alpha value to the howling prevention threshold.

20. The non-transitory computer-readable medium of claim 17, the operations further including adjusting the sound control gain using exponential convergence behavior to prevent audio artifacts.
